(19) United States
(12) Patent Application Publication
(10) Pub. No.: US 2009/0003435 A1
(43) Pub. Date: Jan. 1, 2009

(54) Method, medium, and apparatus for encoding and/or decoding video data

(75) Inventors: Dae-sung Cho, Seoul (KR); Woong-iI Choi, Hwaseong-si (KR); Dae-hee Kim, Suwon-si (KR); Hyun-mun Kim, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/213,374

(22) Filed: Jun. 18, 2008

(30) Foreign Application Priority Data
Jun. 27, 2007 (KR) 10-2007-0063898

(51) Int. Cl. H04N 7/26

(52) U.S. Cl. 375/240.1; 375/240.25; 375/E07.078

(57) ABSTRACT

A method, medium, and apparatus for encoding and/or decoding video by generating a scalable bitstream compatible with at least two video formats generating an enhancement layer identifier, generating a base layer bitstream by encoding a chrominance component of a low-frequency band and a luminance component that are included in video, and generating an enhancement layer bitstream by encoding a chrominance component of the remaining frequency band other than the low-frequency band that is included in the video.

### CROSS-REFERENCE TO RELATED APPLICATION

This application claims the benefit of Korean Patent Application No. 10-2007-0063898, filed on Jun. 27, 2007, in the Korean Intellectual Property Office, the disclosure of which is incorporated herein in its entirety by reference.

### BACKGROUND

1. Field

One or more embodiments of the present invention relates to a method, medium and apparatus for encoding and/or decoding video data, and more particularly, to a method, medium and apparatus for encoding and/or decoding video in which a scalable bitstream supporting at least two video formats with forward compatibility is generated or decoded.

2. Description of the Related Art

In an video codec according to conventional technology, when the video format of a basic encoder such as a VC-1 encoder, is changed from 4:2:0 to 4:2:2 or 4:4:4, it is impossible for a VC-1 decoder to read and reproduce a bitstream which is generated from the improved encoders having the extended video format. Recently, the necessity for development of a video codec which guarantees forward compatibility and then allows a VC-1 decoder and other improved decoders to restore a bitstream encoded with a variety of video formats as well as the fixed video format, has been increasingly highlighted.

That is, since a new video codec which does not guarantee forward compatibility cannot support a terminal having only a conventional basic video codec, reuse of digital content in both terminals having specifications different from each other becomes impossible. In addition, it will take much time for the new video codec to settle into the market, because the new video codec needs to overcome the already established conventional video codec market.

### SUMMARY

Additional aspects and/or advantages will be set forth in part in the description which follows and, in part, will be apparent from the description, or may be learned by practice of the invention.

One or more embodiments of the present invention provides a video encoding apparatus and method for generating a scalable bitstream supporting at least two video formats with forward compatibility.

One or more embodiments of the present invention also provides a video decoding apparatus and method for decoding a scalable bitstream supporting at least two video formats with forward compatibility.

Additional aspects and/or advantages will be set forth in part in the description which follows and, in part, will be apparent from the description, or may be learned by practice of the invention.

According to an aspect of the present invention, there is provided a video encoding method of generating a scalable bitstream compatible with at least two video formats with forward compatibility, wherein the scalable bitstream includes: an enhancement layer identifier; a base layer bitstream being obtained by encoding a chrominance component of a low-frequency band and a luminance component that are included in video; and an enhancement layer bitstream being obtained by encoding a chrominance component of the remaining frequency band other than the low-frequency band in the video.

According to another aspect of the present invention, there is provided a video encoding apparatus for generating a scalable bitstream compatible with at least two video formats with forward compatibility, the apparatus including: an analysis filtering unit to filter a chrominance component of the video to obtain a chrominance component of a low-frequency band and a chrominance component of another frequency band; a first encoding unit to generate a base layer bitstream by encoding a luminance component and the chrominance component of the low-frequency band of the video; a second encoding unit to generate an enhancement layer bitstream by encoding the chrominance component of the remaining frequency band other than the low-frequency band; and a bitstream combining unit to generate the scalable bitstream by combining the base layer bitstream and the enhancement layer bitstream and to insert an enhancement layer identifier into the combined result.

According to another aspect of the present invention, there is provided a video decoding apparatus including: an enhancement layer identifier checking unit to check if a bitstream contains an enhancement layer identifier; a first decoding unit to generate a restored video in a first video format by decoding a base layer bitstream included in the bitstream, which does not include the enhancement layer identifier; a second decoding unit to generate a chrominance component of the remaining frequency band other than a low-frequency band by decoding an enhancement layer bitstream included in the bitstream, which includes the enhancement layer identifier; and a synthesis filtering unit to generate a restored video in a second video format by combining a chrominance component of the low-frequency band that is included in the restored video in the first video format generated by the first decoding unit and the chrominance component of the remaining frequency band generated by the second decoding unit, and to combine the combined result and a luminance component included in the restored video in the first video format.

According to another aspect of the present invention, there is provided a video decoding method including: checking if a bitstream contains an enhancement layer identifier; generating restored video in a first video format by decoding a base layer bitstream included in the bitstream, which does not contain the enhancement layer identifier; generating a chrominance component of another frequency band by decoding an enhancement layer bitstream included in the bitstream, which contains the enhancement layer identifier; and generating a restored video in a second video format by combining a chrominance component of a low-frequency band that is included in the restored video in the first video format and a chrominance component of a high-frequency band that is included in the chrominance component in the remaining frequency band other than a low-frequency band and then using a luminance component included in the restored video in the first video format.

According to another aspect of the present invention, there is provided a computer readable medium having computer readable code to implement a video encoding method of generating a scalable bitstream supporting at least two video formats with forward compatibility, wherein the scalable bitstream includes: an enhancement layer identifier; a base layer bitstream being obtained by encoding a chrominance component of a low-frequency band and a luminance component that are included in video; and an enhancement layer bitstream being obtained by encoding a chrominance component of the remaining frequency band other than the low-frequency band that is included in the video.

According to another aspect of the present invention, there is provided a computer readable medium having computer readable code to implement a video decoding method including: checking if a bitstream includes an enhancement layer identifier; generating restored video in a first video format by decoding a base layer bitstream included in the bitstream, which does not include the enhancement layer identifier; generating a chrominance component of another frequency band by decoding an enhancement layer bitstream included in the bitstream, which includes the enhancement layer identifier; and generating a restored video in a second video format by combining a chrominance component of a low-frequency band that is included in the restored video in the first video format and a chrominance component of a high-frequency band that is included in the chrominance component in the remaining frequency band other than a low-frequency band and then using a luminance component included in the restored video in the first video format. According to another aspect of the present invention, there is provided a video data decoding method including: receiving an enhancement layer identifier; decoding video data in a first video format which is different from a second video format based on the enhancement layer identifier.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram explaining concepts of a video encoding apparatus and video decoding apparatus, according to an embodiment of the present invention;

FIG. 2 is a diagram illustrating an example of syntax of a scalable bitstream which is obtained from a video encoding apparatus, according to an embodiment of the present invention;

FIGS. 3A and 3B are diagrams illustrating examples of information included in each level illustrated in FIG. 2, according to an embodiment of the present invention;

FIG. 4 is a diagram illustrating an example of a start code which is an interval for loading an enhancement layer identifier in a video encoding apparatus, according to an embodiment of the present invention;

FIG. 5 is a block diagram of a video encoding apparatus according to an embodiment of the present invention;

FIG. 6 is a block diagram of a video decoding apparatus according to an embodiment of the present invention;

FIG. 7 is a block diagram of a video encoding apparatus according to another embodiment of the present invention;

FIG. 8 is a block diagram of a video decoding apparatus according to another embodiment of the present invention;

FIG. 9A is a block diagram of a video decoding apparatus guaranteeing forward compatibility and supporting a 4:2:0 format according to an embodiment of the present invention;

FIG. 9B is a block diagram of a video decoding apparatus guaranteeing forward compatibility and supporting a 4:2:2 format according to an embodiment of the present invention;

FIG. 10A is a block diagram illustrating in detail an encoding unit, such as that shown in FIG. 5 or 7, according to an embodiment of the present invention;

FIG. 10B is a block diagram illustrating in detail a decoding unit, such as that shown in FIG. 6, 8, 9A or 9B, according to an embodiment of the present invention;

FIGS. 11A and 11B are diagrams illustrating a 4:4:4 format;

FIGS. 12A and 12B are diagrams illustrating a 4:2:2 format;

FIGS. 13A and 13B are diagrams illustrating a 4:2:0 format;

FIG. 14 is a block diagram illustrating application of a wavelet-based analysis filter and a synthesis filter for extending a video format according to an embodiment of the present invention;

FIG. 15 is a circuit diagram illustrating application of an analysis filter and a synthesis filter using a lifting structure according to an embodiment of the present invention;

FIG. 16A is a block diagram illustrating a video encoding method of extending a 4:2:0 format to a 4:2:2 format by applying an analysis filter and a synthesis filter that have a lifting structure to a chrominance component in a vertical direction, according to an embodiment of the present invention;

FIG. 16B is a block diagram illustrating a video decoding method of extending a 4:2:0 format to a 4:2:2 format by applying an analysis filter and a synthesis filter that have a lifting structure to a chrominance component in a vertical direction, according to an embodiment of the present invention;

FIG. 17A is a block diagram illustrating a video encoding method of extending a 4:2:0 format to a 4:2:2 or 4:4:4: format by applying an analysis filter and a synthesis filter that have a lifting structure to a chrominance component in a horizontal/vertical direction, according to an embodiment of the present invention;

FIG. 17B is a block diagram illustrating a video decoding method of extending a 4:2:0 format to a 4:2:2 or 4:4:4: format by applying an analysis filter and a synthesis filter that have a lifting structure to a chrominance component in a horizontal/vertical direction, according to an embodiment of the present invention;

FIG. 18 is a diagram illustrating application of a Haar filter having a lifting structure to a one-dimensional (1D) pixel array according to an embodiment of the present invention;

FIG. 19 is a diagram illustrating application of a 5/3 tap wavelet filter having a lifting structure to a 1D pixel array according to an embodiment of the present invention;

FIG. 20 is a diagram illustrating a hierarchical structure of a bitstream for extending a 4:2:0 format to a 4:2:2 format according to an embodiment of the present invention;

FIG. 21 is a diagram illustrating a hierarchical structure of a bitstream for extending a 4:2:0 format to a 4:2:2 format and a 4:4:4 format according to an embodiment of the present invention;

FIG. 22 is a diagram illustrating application of odd-numbered symmetrical filters for 2:1 down sampling according to an embodiment of the present invention;

FIG. 23 is a diagram illustrating application of even-numbered symmetrical filters for 2:1 down sampling according to an embodiment of the present invention;

FIG. 24 is a diagram illustrating a distribution of filter values of odd-numbered symmetrical filters; and

FIG. 25 is a diagram illustrating a distribution of filter values of even-numbered symmetrical filters.

### DETAILED DESCRIPTION OF THE EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, embodiments are merely described below, by referring to the figures, to explain aspects of the present invention.

FIG. 1 is a block diagram illustrating the concepts of a video encoding apparatus and a scalable video decoding apparatus according to an embodiment of the present invention. FIG. 1 illustrates a first encoder 113 acting as a basic encoder and a second encoder 117 acting as an improved encoder (encoder part). FIG. 1 also illustrates a first decoder 153 acting as a basic decoder and corresponding to the first encoder 113 and a second decoder 157 acting as an improved decoder and corresponding to the second encoder 117 (decoder part).

FIG. 1 is a diagram explaining concepts of a video encoding apparatus and video decoding apparatus, according to an embodiment of the present invention. As an encoder part, examples of a first encoder 113 performing the role of a basic encoder and a second encoder 117 performing the role of an improved encoder will be explained. As a decoder part, examples of a first decoder 153 performing the role of a basic decoder and corresponding to the first encoder 113, and a second decoder 157 performing the role of an improved decoder and corresponding to the second encoder 117 will be explained. In an embodiment of the present invention, the first encoder 113 generates a bitstream according to a first video format, and the second encoder 117 generates a scalable bitstream according to a second video format and/or a third video format supporting the first video format.

For convenience of explanation, an example will be given, in which the first video format is 4:2:0, the second video format is 4:2:2, and the third video format is 4:4:4. According to the example, a VC-1 encoder supporting 4:2:0 format may be employed as the first encoder 113.

Referring to FIG. 1, a bitstream 131 generated in the first encoder 113 can be decoded in the second decoder 157 as well as in the first decoder 153. A scalable bitstream 137 generated in the second encoder 117 can be decoded in the second decoder 157. In the first decoder 153, a base layer bitstream in the scalable bitstream 137 can be decoded in a state in which an enhancement layer bitstream included in the scalable bitstream 137 is ignored. The second encoder 117 which is capable of providing this forward compatibility corresponds to a video encoding apparatus of the present invention, while the second decoder 157 corresponds to a video decoding apparatus of the present invention.

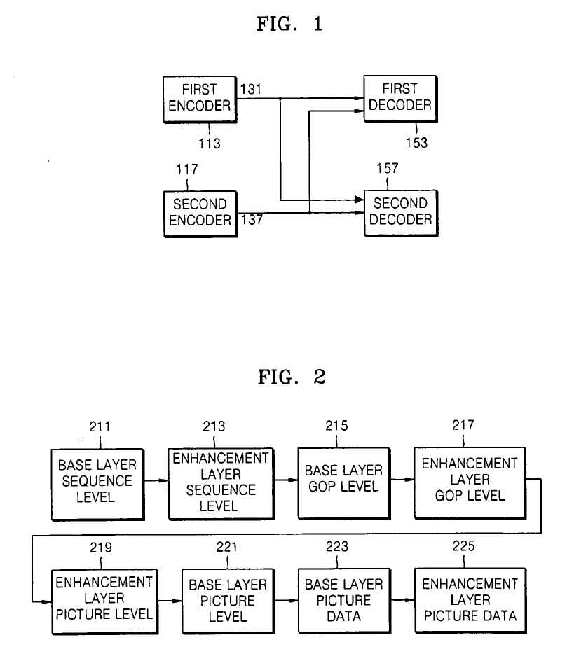

FIG. 2 is a diagram illustrating an example of syntax of a scalable bitstream which is obtained from a video encoding apparatus according to an embodiment of the present invention. The syntax is composed of a base layer bitstream and an enhancement layer bitstream.

More specifically, the scalable bitstream illustrated in FIG. 2 is composed of a base layer sequence level 21 1, an enhancement layer sequence level 213, a base layer group of pictures (GOP) level 215, an enhancement layer GOP level 217, an enhancement layer picture level 219, a base layer picture level 221, a base layer picture data 223, and an enhancement layer picture data 225. Although the enhancement layer picture level 219 is positioned in front of the base layer picture level 221 in this case, the enhancement layer picture level 219 may be positioned behind the base layer picture level 221. The base layer GOP level 215 and the enhancement layer GOP level 217 can be optionally in the scalable bitstream.

Here, a sequence is formed with at least one or more encoded pictures or at least one or more GOPs. A GOP is formed with at least one or more encoded pictures, and in the case of a VC-1 codec, an entry-point may be used. Here, the first picture in each GOP can provide a random access function. Meanwhile, a picture is divided into macroblocks, and if the video format is 4:2:0, each macroblock is formed of 4 luminance blocks and 2 chrominance blocks.

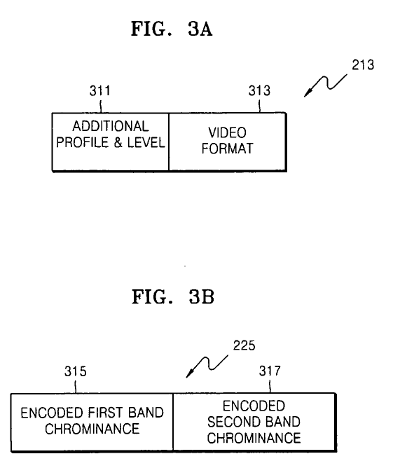

FIGS. 3A and 3B are diagrams illustrating examples of information included in each level illustrated in FIG. 2 according to an embodiment of the present invention.

FIG. 3A illustrates information included in the enhancement layer sequence level 213, and includes an additional profile and level 311 which can be supported in an enhancement layer, and a video format 313. Here, if a video format 313 can be defined in the base layer sequence level 211, the video format 313 does not have to be included in the enhancement layer sequence level 213. FIG. 3B illustrates information included in the enhancement layer picture data 225, and includes a first band chrominance video 315 or a second band chrominance video 315 corresponding to the extended video format.

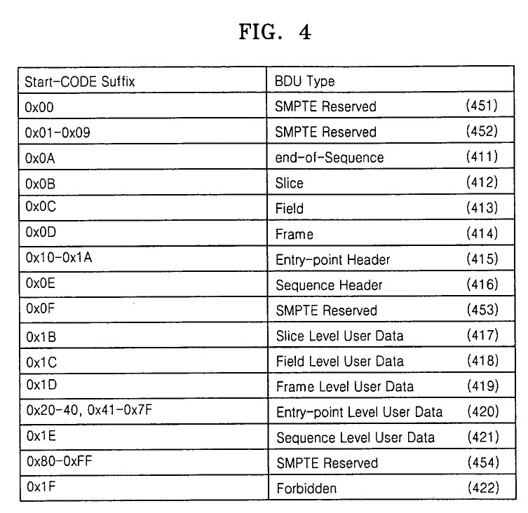

FIG. 4 is a diagram illustrating areas for loading information related to an enhancement layer, including an enhancement layer identifier, in a scalable bitstream obtained from a video encoding apparatus according to an embodiment of the present invention. If the first encoder 113 is a VC-1 encoder, a start code of a 4-byte unit may be used in an embodiment of the present invention. In the VC-1 encoder, a start code can be supported at an advanced profile or a profile higher than the advanced profile. Meanwhile, the start code may be included in the first area of the header of each level.

A process of loading information related to an enhancement layer in a start code of the VC-1 used as an embodiment of the present invention will now be explained with reference to FIG. 4. Among bitstream data unit (BDU) types defined in a suffix in a start code, reserved areas 451, 452, 453, and 454 reserved for future use are used for loading information related to the enhancement layer. Here, the BDU means a compression data unit that can be parsed independently of other information items in an identical layer level. For example, the BDU may be a sequence header, an entry point header, an encoded picture or a slice. Among the BDU types defined in the suffix of the start code, the remaining areas 411 through 421, excluding a forbidden area 422, are for loading information related to a base layer. Here, the start code is only an example, and other parts in the elements of a bitstream may also be used.

Meanwhile, an enhancement layer includes a sequence level, a GOP level, a frame level, a field level, and a slice level. According to an embodiment of the present invention, information of the enhancement layer may be included in one of the second reserved area 452 and the fourth reserved area 454. More specifically, a start code is included in a header for a sequence level of the enhancement layer as ‘0x09’ in the second reserved area 452 or ‘0x40’ in the fourth reserved area 454. A start code is included in a header for a GOP level of the enhancement layer as ‘0x08’ in the second reserved area 452 or ‘0x3F’ in the fourth reserved area 454. A start code is included in a header for a frame level of the enhancement layer as ‘0x07’ in the second reserved area 452 or ‘0x3E’ in the fourth reserved area 454. A start code is included in a header for a field level of the enhancement layer as ‘0x06’ in the second reserved area 452 or ‘0x3D’ in the fourth reserved area 454. A start code for enhancement chrominance data is included in a header for enhancement layer data as ‘0x06’ in the second reserved area 452 or ‘0x3C’ in the fourth reserved area 454.

This will now be explained in more detail.

Examples of Information items that can be included in the start code of the header for the enhancement layer sequence level which is defined as ‘0x09’ in the second reserved area 452 include information on an additional profile and level that can be achieved by the enhancement layer in addition to a base layer, and information on a video format. More specifically, in the sequence level of the base layer, a profile is defined by 2 bits, and ‘3’ indicates an advanced profile and ‘0-2’ indicates a reserved area.

A level is defined by 3 bits, ‘000’ indicates AP@L0, ‘001’ indicates AP@L1, ‘010’ indicates AP@L2, ‘011’ indicates AP@L3, ‘100’ indicates AP@L4, and ‘101-111’ indicates a reserved area. Meanwhile, as information on the enhancement layer, information on an extended video format may be included. The video format information may be expressed by using a variable included in the sequence level of the base layer, for example, in the case of the VC-1 encoder, a ‘COLORDIFF’ variable. The video format information may also be included in ‘0x09’ in the second reserved area 452. That is, when a variable of the base layer is used, the enhancement layer does not have to transmit the information of the extended video format separately. In the example of the ‘COLORDIFF’ variable, ‘1’ is used for defining a 4:2:0 video format, and ‘2’ and ‘3’ are specified as reserved areas. Accordingly, the variable can be used for defining a 4:2:2 video format and a 4:4:4 video format. Meanwhile, as information on the enhancement layer, an additional hypothetical reference decoder (HRD) variable may be included. The HRD variable is a virtual video buffer variable which a decoder refers to for operating a buffer.

If a video format does not change in units of GOPs, the start code of the header for the enhancement layer GOP level which is defined as ‘0x08’ in the second reserved area 452 is not necessary, and is designated as a reserved area. If the video format is changed in units of GOPs, the start code is necessary.

If the video format of the enhancement layer is not changed in comparison with the base layer, the start code for the header of the enhancement layer data which is defined as ‘0x05’ in the second reserved area 452 is not necessary, and therefore is designated as a reserved area. That is, if the video formats of the base layer and the enhancement layer are identically 4:2:0, data for 4 luminance blocks and 2 chrominance blocks forming one macroblock are transmitted from the base layer. Meanwhile, if the video formats of the base layer and the enhancement layer are different from each other, for example, if the video format of the base layer is 4:2:0 and the video format of the enhancement layer is 4:2:2 or if the video format of the base layer is 4:2:0 and the video format of the enhancement layer is 4:4:4, data for 4 luminance blocks and 2 chrominance blocks are transmitted from the base layer, and at the same time, data for a chrominance residue block corresponding to the video format is transmitted from the enhancement layer so that the extended video format can be supported. Meanwhile, data for 4 luminance blocks are identical irrespective of the video formats, and the enhancement layer does not have to transmit separate data.

Meanwhile, information related to the enhancement layer is not restricted to the start codes described in FIG. 4, and can be included in a reserved area which is reserved for future use in a sequence level, a GOP level, a picture level, a macroblock level or a block level. Also, an enhancement layer identifier can be included in a variety of ways in a variety of layers of a network protocol or a system layer for loading and packaging a video bitstream as a payload in order to transmit the bitstream.

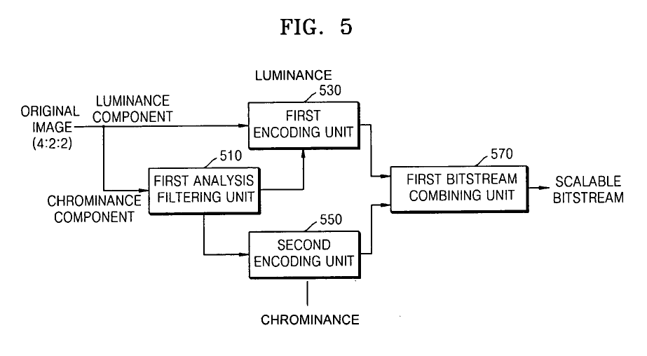

FIG. 5 is a block diagram of a video encoding apparatus according to an embodiment of the present invention. The video encoding apparatus may include a first analysis filtering unit 510, a first encoding unit 530, a second encoding unit 550, and a first bitstream combining unit 570. The first analysis filtering unit 510, the first encoding unit 530, the second encoding unit 550, and the first bitstream combining unit 570 may be implemented by using at least one processor (not shown).

Referring to FIG. 5, the first analysis filtering unit 510 performs filtering on the chrominance component of a 4:2:2 original video to divide the chrominance component into a low-frequency band and a high-frequency band. In this case, wavelet filtering may be performed in a vertical direction. The chrominance component of the low-frequency band is provided to the first encoding unit 530 and the chrominance component of the high-frequency band is provided to the second encoding unit 550.

The first encoding unit 530 receives a luminance component of the 4:2:2 original video and the chrominance component of the low-frequency band, reconstructs a 4:2:0 video, and then encodes the reconstructed 4:2:0 video to obtain a base layer bitstream.

The second encoding unit 550 encodes the chrominance component of the high-frequency band received from the first analysis filtering unit 510 to obtain an enhancement layer bitstream for making a 4:2:2 format.

The first bitstream combining unit 570 obtains a scalable bitstream including an enhancement layer identifier by combining the base layer bitstream received from the first encoding unit 530 and the enhancement layer bitstream received from the second encoding unit 550.

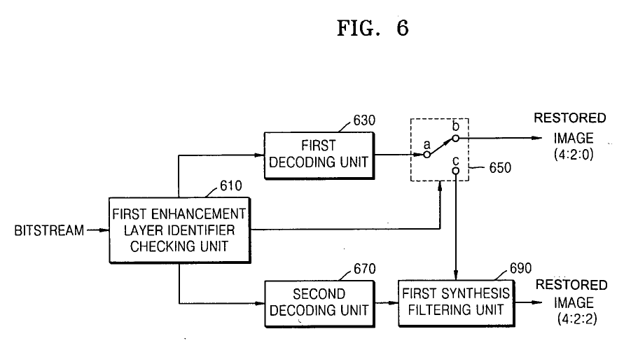

FIG. 6 is a block diagram of a video decoding apparatus according to an embodiment of the present invention, which corresponds to the video encoding apparatus illustrated in FIG. 5. The video decoding apparatus may include a first enhancement layer identifier checking unit 610, a first decoding unit 630, a first switching unit 650, a second decoding unit 670, and a first synthesis filtering unit 690. The first enhancement layer identifier checking unit 610, the first decoding unit 630, the first switching unit 650, the second decoding unit 670, and the first synthesis filtering unit 690 may be implemented by using at least one processor (not shown).

Referring to FIG. 6, the first enhancement layer identifier checking unit 610 checks whether a received bitstream includes an enhancement layer identifier, and directly provides the bitstream, i.e. the base layer bitstream, to the first decoding unit 630 if the bitstream does not contain the enhancement layer identifier. If the bitstream includes the enhancement layer identifier, a base layer bitstream and an enhancement layer bitstream are separated from the bitstream, i.e. the scalable bitstream, and then respectively provided to the first decoding unit 630 and the second decoding unit 670. Also, the first enhancement layer identifier checking unit 610 outputs a first control signal for switching on or off the first switching unit 650 depending on whether the bitstream includes the enhancement layer identifier.

The first decoding unit 630 encodes the base layer bitstream received from the first enhancement layer identifier checking unit 610 so as to obtain restored video in a 4:2:0 format regardless of whether the bitstream includes the enhancement layer identifier.

The first switching unit 650 operates in response to the first control signal received from the first enhancement layer identifier checking unit 610, and then either directly outputs a 4:2:0 restored video received from the first decoding unit 630 or provides the 4:2:0 restored video to the first synthesis filtering unit 690. That is, if the first control signal indicates that the bitstream does not include the enhancement layer identifier, a terminal a and a terminal b included in the first switching unit 650 are connected to each other and thus the 4:2:0 restored video supplied to the first switching unit 650 from the first decoding unit 630 is directly output. If the first control signal indicates that the bitstream includes the enhancement layer identifier, the terminal a and a terminal c included in the first switching unit 650 are connected to each other and thus the 4:2:0 restored video is provided to the first synthesis filtering unit 690.

If the bitstream includes the enhancement layer identifier, the second decoding unit 670 decodes the enhancement layer bitstream received from the first enhancement layer identifier checking unit 610, thus obtaining a restored chrominance component of a high-frequency band.

The first synthesis filtering unit 690 receives the 4:2:0 restored video from the first switching unit 650 and the restored chrominance component of the high-frequency band from the second decoding unit 670, and performs filtering on a chrominance component of a low-frequency band contained in the 4:2:0 restored video and the restored chrominance component of the high-frequency band, thus obtaining a 4:2:2 restored video. In this case, wavelet filtering in a vertical direction may be performed corresponding to the first analysis filtering unit 510 illustrated in FIG. 5.

As described above, the video decoding apparatus illustrated in FIG. 6 can decode both a bitstream generated by a video encoding apparatus supporting the 4:2:0 format and a bitstream generated by a video encoding apparatus supporting the 4:2:0 and 4:2:2 format.

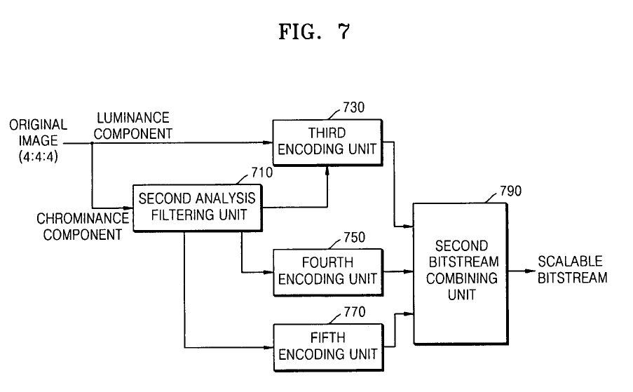

FIG. 7 is a block diagram of a video encoding apparatus according to another embodiment of the present invention. Referring to FIG. 7, the video encoding apparatus may include a second analysis filtering unit 710, a third encoding unit 730, a fourth encoding unit 750, a fifth encoding unit 770, and a second bitstream combining unit 790. The second analysis filtering unit 710, the third encoding unit 730, the fourth encoding unit 750, the fifth encoding unit 770, and the second bitstream combining unit 790 may be implemented by using at least one processor (not shown).

Referring to FIG. 7, the second analysis filtering unit 710 performs filtering on the chrominance component of a 4:4:4 original video to divide the chrominance component into a plurality of frequency bands. In this case, wavelet filterings may be respectively and sequentially performed in a horizontal direction and in a vertical direction. In detail, first, the 4:4:4 original video is divided into a low-frequency band and a high-frequency band by using a vertical-direction analysis filter not shown. Then the low-frequency band and the high-frequency band are divided into a low-low (LL) frequency band, a HL frequency band, a LH frequency band, and a HH frequency band by using a horizontal-direction analysis filter not shown. However, it is noted that the vertical-direction analysis filter and the horizontal-direction analysis filter are in the second analysis filtering unit 710. A chrominance component of the LL frequency band is provided to the third encoding unit 730, a chrominance component of the LH frequency band is provided to the fourth encoding unit 750, and the chrominance components of the HL and HH frequency bands are provided to the fifth encoding unit 770.

The third encoding unit 730 receives a luminance component of the 4:4:4 original video and the chrominance component of the LL frequency band, reconstructs the 4:2:0 video, and then encodes the reconstructed 4:2:0 video, thus obtaining a base layer bitstream.

The fourth encoding unit 750 obtains a first enhancement layer bitstream for making a 4:2:2 format by encoding the chrominance component of the LH frequency band received from the second analysis filtering unit 710.

The fifth encoding unit 770 obtains a second enhancement layer bitstream for making a 4:4:4 format by encoding the chrominance components of the HL and HH frequency bands received from the second analysis filtering unit 710.

The second bitstream combining unit 790 receives the base layer bitstream from the third encoding unit 730, the first enhancement layer bitstream from the fourth encoding unit 750, and the second enhancement layer bitstream from the fifth encoding unit 770, and combines them to obtain a scalable bitstream including an enhancement layer identifier.

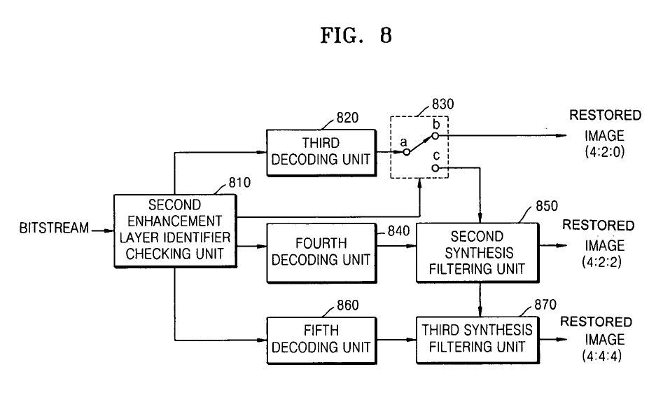

FIG. 8 is a block diagram of a video decoding apparatus according to an embodiment of the present invention, which corresponds to the video encoding apparatus illustrated in FIG. 7, according to another embodiment of the present invention. The video decoding apparatus may include a second enhancement layer identifier checking unit 810, a third decoding unit 820, a second switching unit 830, a fourth decoding unit 840, a second synthesis filtering unit 850, a fifth decoding unit 860, and a third synthesis filtering unit 870. The second enhancement layer identifier checking unit 810, the third decoding unit 820, the second switching unit 830, the fourth decoding unit 840, the second synthesis filtering unit 850, the fifth decoding unit 860, and the third synthesis filtering unit 870 may be implemented by using at least one processor (not shown).

Referring to FIG. 8, the second enhancement layer identifier checking unit 810 checks if a received bitstream includes an enhancement layer identifier, and directly transmits the bitstream, i.e. the base layer bitstream, to the third decoding unit 820 if the bitstream does not include the enhancement layer identifier. If the bitstream includes the enhancement layer identifier, the second enhancement layer identifier checking unit 810 separates a base layer bitstream, a first enhancement layer bitstream and a second enhancement layer bitstream from the bitstream, i.e. the scalable bitstream, and respectively provides them to the third decoding unit 820, the fourth decoding unit 840 and the fifth decoding unit 860. Also, the second enhancement layer identifier checking unit 810 outputs a second control signal for switching the second switching unit 830 on or off depending on whether the bitstream includes the enhancement layer identifier.

The third decoding unit 820 obtains a 4:2:0 restored video by decoding the base layer bitstream received from the second enhancement layer identifier checking unit 810, regardless of whether the bitstream includes the enhancement layer identifier.

The second switching unit 830 operates in response to the second control signal received from the second enhancement layer identifier checking unit 810, and then either directly outputs the 4:2:0 restored video received from the third decoding unit 820 or transmits it to the second synthesis filtering unit 850. That is, if the second control signal indicates that the bitstream does not include the enhancement layer identifier, a terminal a and a terminal b in the second switching unit 830 are connected to each other and thus directly output the 4:2:0 restored video received from the third decoding unit 820. If the second control signal indicates that the bitstream includes the enhancement layer identifier, the terminal a and a terminal c in the second switching unit 830 are connected to each other and thus deliver the 4:2:0 restored video received from the third decoding unit 820 to the second synthesis filtering unit 850.

If the bitstream includes the enhancement layer identifier, the fourth decoding unit 840 obtains a restored chrominance component of an LH frequency band by decoding the first enhancement layer bitstream received from the second enhancement layer identifier checking unit 810.

The second synthesis filtering unit 850 receives the 4:2:0 restored video from the second switching unit 830 and the restored chrominance component of the LH frequency band from the fourth decoding unit 840, and then performs filtering on a chrominance component of an LL frequency band included in the 4:2:0 restored video and chrominance component of the LH frequency band to obtain a 4:2:2 restored video. In this case, wavelet filtering in a vertical direction may be performed corresponding to the second analysis filtering unit 710. The 4:2:2 restored video obtained by the second synthesis filtering unit 850 may be directly output or may be transmitted to the third synthesis filtering unit 870.

If the bitstream includes the enhancement layer identifier, the fifth decoding unit 860 obtains restored chrominance components of HL and HH frequency bands by decoding the second enhancement layer bitstream received from the second enhancement layer identifier checking unit 810.

The third synthesis filtering unit 870 receives the 4:2:2 restored video from the second synthesis filtering unit 850 and the restored chrominance components of the HL and HH frequency bands from the fifth decoding unit 860, and then performs filtering on chrominance components of LL and LH frequency bands contained in the 4:2:2 restored video and the restored chrominance components of the HL and HH frequency bands in order to obtain a 4:4:4 restored video. In this case, wavelet filtering in a horizontal direction may be performed corresponding to the second analysis filtering unit 710.

As described above, the video decoding apparatus illustrated in FIG. 8 can decode not only a bitstream received from a video encoding apparatus compatible to the 4:2:0 format but also a bitstream received from a video encoding apparatus compatible to the 4:2:0 and 4:2:2 format or the 4:2:0 and 4:4:4 format.

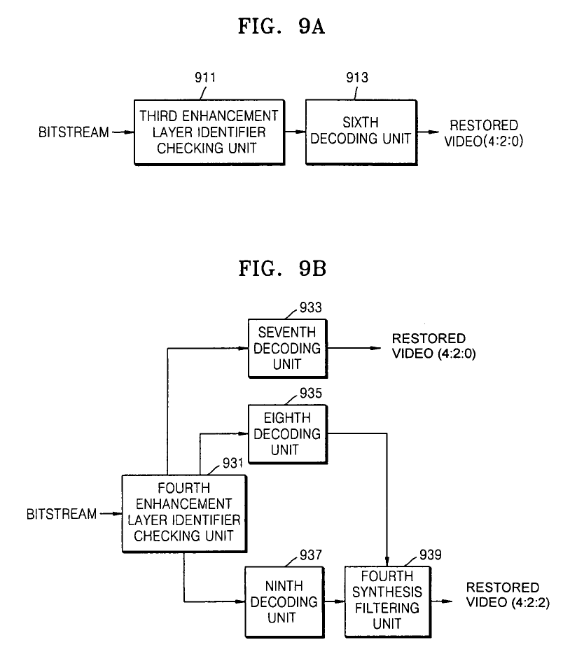

FIG. 9A is a block diagram of a video decoding apparatus guaranteeing forward compatibility and compatible with a 4:2:0 format according to an embodiment of the present invention. FIG. 9B is a block diagram of a video decoding apparatus guaranteeing forward compatibility and compatible with a 4:2:2 format according to an embodiment of the present invention. The video decoding apparatus illustrated in FIG. 9A includes a third enhancement layer identifier checking unit 911 and a sixth decoding unit 913. The video decoding apparatus illustrated in FIG. 9B includes a fourth enhancement layer identifier checking unit 931, a seventh decoding unit 933, an eighth decoding unit 935, a ninth decoding unit 937 and a fourth synthesis filtering unit 939.

Referring to FIG. 9A, the third enhancement layer identifier checking unit 911 checks whether a bitstream includes an enhancement layer identifier, and directly outputs the bitstream, i.e. the base layer bitstream, to the sixth decoding unit 913 if the bitstream does not include the enhancement layer identifier. If the bitstream does not include the enhancement layer identifier, the third enhancement layer identifier checking unit 911 extracts a base layer bitstream from the bitstream, i.e. the scalable bitstream, and then transmits it to the sixth decoding unit 913.

The sixth decoding unit 913 obtains a 4:2:0 restored video by decoding a bitstream or a base layer bitstream in a 4:2:0 format from the third enhancement layer identifier checking unit 911.

Accordingly, not only can the video decoding apparatus illustrated in FIG. 9A restore the original video from a bitstream received from a general video encoding apparatus compatible with a 4:2:0 format but it can also extract a base layer bitstream from a scalable bitstream and then restore the original video from the base layer bitstream.

Referring to FIG. 9B, the fourth enhancement layer identifier checking unit 931 checks whether a bitstream contains an enhancement layer identifier, and directly provides the bitstream, i.e. the base layer bitstream, to the seventh decoding unit 933 if the bitstream does not include the enhancement layer identifier. If the bitstream includes the enhancement layer identifier, the fourth enhancement layer identifier checking unit 931 extracts a base layer bitstream and a first enhancement layer bitstream from the bitstream, i.e. the scalable bitstream, and respectively transmits the base layer bitstream and the first enhancement layer bitstream to the eighth decoding unit 935 and the ninth decoding unit 937, respectively.

The eighth decoding unit 935 obtains a 4:2:0 restored video by decoding the base layer bitstream received from the fourth enhancement layer identifier checking unit 931, and provides the 4:2:0 restored video to the fourth synthesis filtering unit 939.

The ninth decoding unit 937 obtains a restored chrominance component of a LH frequency band by decoding the first enhancement layer bitstream received from the fourth enhancement layer identifier checking unit 931.

The fourth synthesis filtering unit 939 receives the 4:2:0 restored video from the eighth decoding unit 935 and the chrominance component of the LH frequency band from the ninth decoding unit 937, and then performs filtering on a chrominance component of an LL frequency band in the 4:2:0 restored video and on the restored chrominance component of the LH frequency band to obtain a 4:2:2 restored video. In this case, wavelet filtering in a vertical direction may be performed corresponding to the second analysis filtering unit 710 illustrated in FIG. 7.

Not only can the video decoding apparatus illustrated in FIG. 9B restore the original video from a bitstream received from a general video encoding apparatus supporting the 4:2:2 format but it can also extract a base layer bitstream and a first enhancement layer bitstream even a scalable bitstream is input and then restore the original video from them.

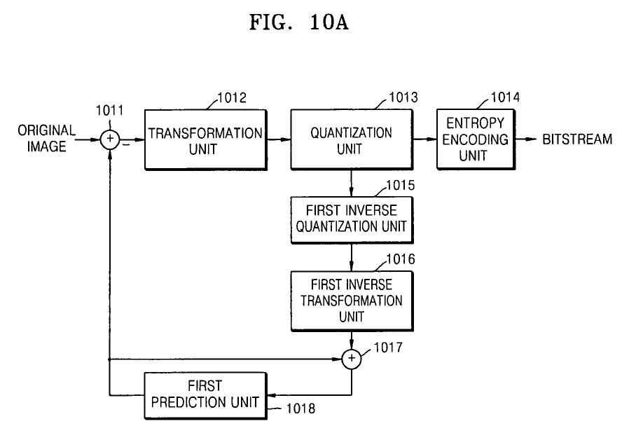

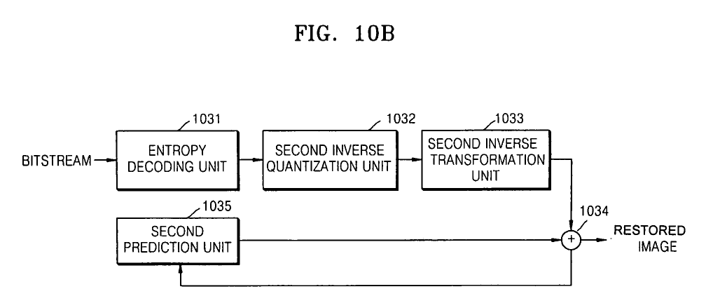

FIG. 10A is a block diagram illustrating in detail an encoding unit, such as the encoding units 530, 550, 730, 750, 770 shown in FIGS. 5 and 7, according to an embodiment of the present invention. FIG. 10B is a block diagram illustrating in detail a decoding unit, such as the decoding units 630, 670, 820, 840, 860, 913, 933, 935, 937 shown in FIG. 6, 8, 9A and 9B, according to an embodiment of the present invention. The encoding unit of FIGS. 10A and decoding unit of FIG. 10B indicate the Motion-Compensated Discrete Cosine Transform (MC-DCT) video codec commonly used in MPEG-2, MPEG-4, and H.264 but are not limited thereto and thus may be modified or altered according to application requirements. The encoding unit illustrated in FIG. 10A includes a subtraction unit 1011, a transformation unit 1012, a quantization unit 1013, an entropy encoding unit 1014, a first inverse quantization unit 1015, a first inverse transformation unit 1016, a first addition unit 1017 and a first prediction unit 1018. The decoding unit illustrated in FIG. 10B includes an entropy decoding unit 1031, a second inverse quantization unit 1032, a second inverse transformation unit 1033, a second addition unit 1034 and a second prediction unit 1035. The encoding unit illustrated in FIG. 10A and the decoding unit illustrated in FIG. 10B are well known to the field to which the present invention pertains and therefore a detailed description of their operations will be omitted.

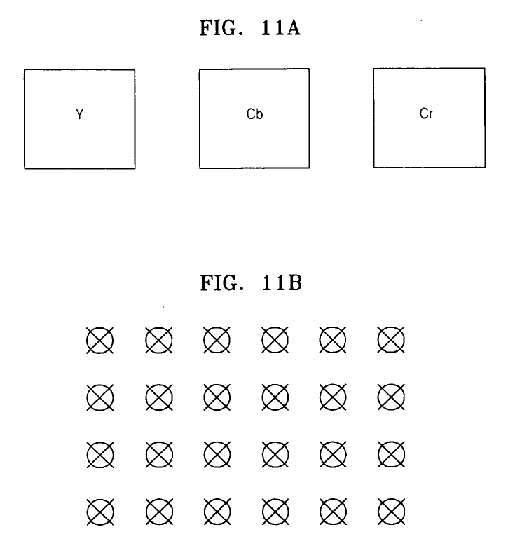

FIGS. 11A and 11B are diagrams illustrating a 4:4:4 format, where a luminance component and chrominance components of a frame have the same resolution and the phase of the chrominance component is the same as those of the luminance components.

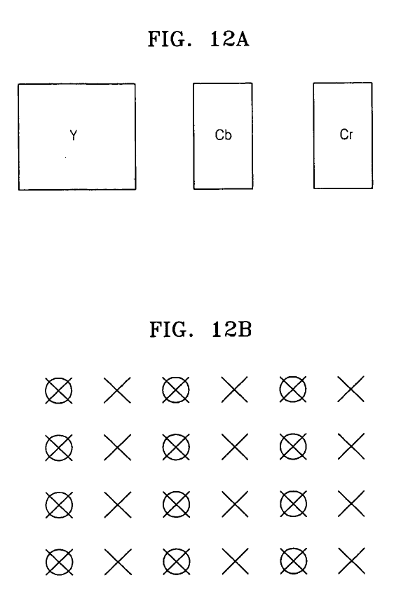

FIGS. 12A and 12B are diagrams illustrating a 4:2:2 format, where chrominance components are sampled at a ratio of 2:1, thus reducing the resolution thereof in the horizontal direction. In this case, the phases of the down-sampled chrominance components and a luminance component are the same at the location of a pixel both in vertical and horizontal directions.

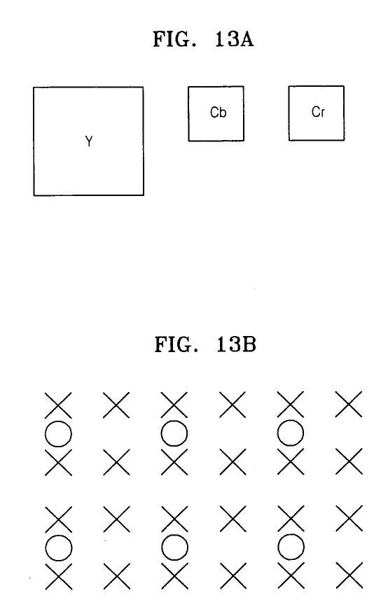

FIGS. 13A and 13B are diagrams illustrating a 4:2:0 format, where chrominance components are sampled at a ratio of 2:1 both in vertical and horizontal directions thus reducing the resolution thereof. In this case, the phases of the down-sampled chrominance components are the same as that of a luminance component at the location of a pixel in the horizontal direction but are shifted by a half pixel in the vertical direction. The extent of phase shifting may vary according to a type of analysis filter applied. In 13B, “X” denotes a luminance component and “0” denotes a chrominance component.

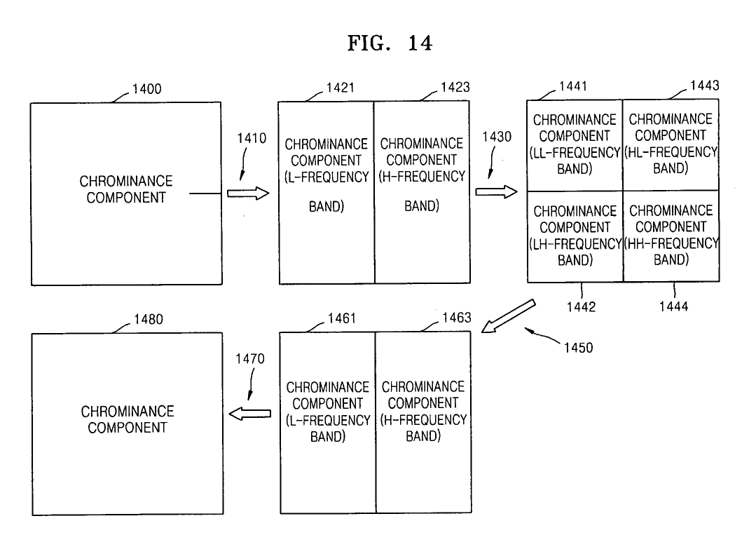

FIG. 14 is a block diagram illustrating application of a wavelet-based analysis filter and a synthesis filter for extending a video format according to an embodiment of the present invention, where resolution change is performed on only chrominance components other than luminance components. For video encoding, wavelet analysis filtering 1410 is performed on a chrominance component 1400 included in a 4:4:4 format in the horizontal direction to divide the chrominance component 1400 into a chrominance component 1421 of a low (L)-frequency band and a chrominance component 1423 of a high (H)-frequency band. In this case, the chrominance component 1421 of the L frequency band and a luminance component form a 4:2:2 format. Then wavelet analysis filtering 1430 is performed on the chrominance component 1421 of the L frequency band and the chrominance component 1423 of the H frequency band in the vertical direction in order to divide the chrominance component 1421 of the L frequency band into a chrominance component 1441 of an LL frequency band and a chrominance component 1442 of an LH frequency band and divide the chrominance component 1423 of the H frequency band into a chrominance component 1443 of an HL frequency band and a chrominance component 1444 of an HH frequency band. In this case, the chrominance component 1441 of the LL frequency band and a luminance component form a 4:2:0 format. Here, if the chrominance component 1442 of the LH frequency band is added to the 4:2:0 format, a 4:2:2 format is obtained. Then, if the chrominance component 1443 of the HL frequency band and the chrominance component 1444 of the HH frequency band are added to the 4:2:2: format, a 4:4:4 format is obtained.

For video decoding that is an inverse operation of the above video encoding, wavelet synthesis filtering 1450 is performed on the chrominance component 1441 of the LL frequency band, the chrominance component 1442 of the LH frequency band, the chrominance component 1443 of the HL frequency band, and the chrominance component 1444 of the HH frequency band in the vertical direction to obtain a chrominance component 1461 of the L frequency band and a chrominance component 1463 of the H frequency band. In this case, the chrominance component 1461 of the L frequency band and a luminance component form a 4:2:2 format. Then wavelet synthesis filtering 1470 is performed on the chrominance component 1461 of the L frequency band and the chrominance component 1463 of the H frequency band in the horizontal direction in order to obtain a chrominance component 1480 that is to be included in a 4:4:4 format. The chrominance component 1480 and a luminance component form the 4:4:4 format.

FIG. 15 is a circuit diagram illustrating application of an analysis filter 1510 and a synthesis filter 1530 using a lifting structure according to an embodiment of the present invention. First, video can be divided into a low-frequency band value having a low-frequency component and a high-frequency band value having a high-frequency component by applying an analysis filter 1510 to a video encoding method. More specifically, a high-frequency band value is obtained by calculating a prediction value from the value of a pixel at an even-numbered location and then calculating the difference between the prediction value and the value of a pixel at an odd-numbered location. The high-frequency band value is set to be an update value and then is combined with the value of the pixel at the even-numbered location in order to obtain a low-frequency band value. The result of applying the analysis filter 1510 using the lifting structure, i.e., the high-frequency band value H[x][y] and low-frequency band value L[x][y] of a pixel at a location (x,y), can be expressed as follows:

H[x][y]=s[x][2y+1]−P(s[x][2y]) L[x][y]=s[x][2y]+U(H[x][y]) (1)

A prediction value P(.) and an update value U(.) for applying the lifting structure can be expressed as follows:

$$P ( s [ x ] [ 2 y ] ) = {\sum }_{i} {p}_{i}^{*} s [ x ] [ 2 ( y + i ) ] \\ U ( H [ x ] [ y ] ) = {\sum }_{i} {u}_{i}^{*} H [ x ] [ y + i ] \qquad ( 2 )$$

If a Haar filter or a 5/3 tap wavelet filter is used, the prediction value P(.) and the update value U(.) can be expressed using Equation (3) or (4), as follows:

$$\begin{matrix}{P}_{Haar} ( s [ 2 y ] [ x ] ) = s [ x ] [ 2 y ] \\ {U}_{Haar} ( H [ x ] [ y ] ) = \frac{1}{2} H [ x ] [ y ] & ( 3 ) \\ {P}_{5 / 3} ( s [ 2 y ] [ x ] ) = \frac{1}{2} ( s [ x ] [ 2 y ] ) + s [ x ] [ 2 y + 2 ] ) \\ {U}_{5 / 3} ( H [ x ] [ y ] ) = \frac{1}{4} ( H [ x ] [ y ] ) + H [ x ] [ y - 1 ] ) & ( 4 )\end{matrix}$$

A method of applying the synthesis filter 1530 to a video decoding process is performed in a backward order to that in which the video encoding method is performed using the analysis filter 1510. That is, the low-frequency band value and the high-frequency band value are combined to restore the original pixel value. In detail, the high-frequency band value is set to be an update value, and then the value of a pixel at an even-numbered location is calculated by subtracting the update value from the low-frequency band value. Then a prediction value is calculated from the value of a pixel at an even-numbered location, and the value of a pixel at an odd-numbered location is calculated by combining the prediction value and the high-frequency band value. The result of applying the synthesis filter 1530 using the lifting structure, that is, the value of a pixel at an even-numbered location (x,2y) and the value of a pixel at an odd-numbered location (x,2y+1), can be expressed as follows:

s[x][2y]=L[x][y]−U(H[x][y]) s[x][2y+1]=H[x][y]+P(s[x][2y]) (5)

Use of the analysis filter 1510 and the synthesis filter 1530 using the lifting structure enables lossless reconstruction. Thus if the analysis filter 1510 and the synthesis filter 1530 are applied to scalable video encoding, it is possible to restore high-quality video by restoring both a base layer and an enhancement layer.

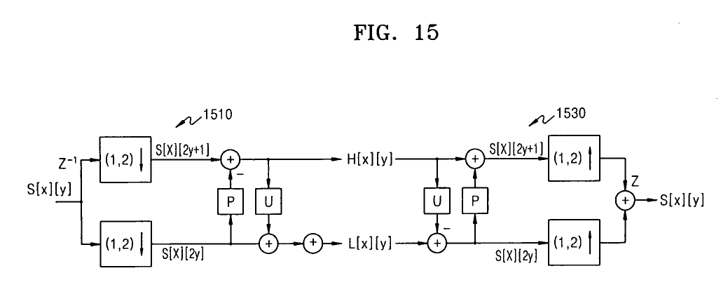

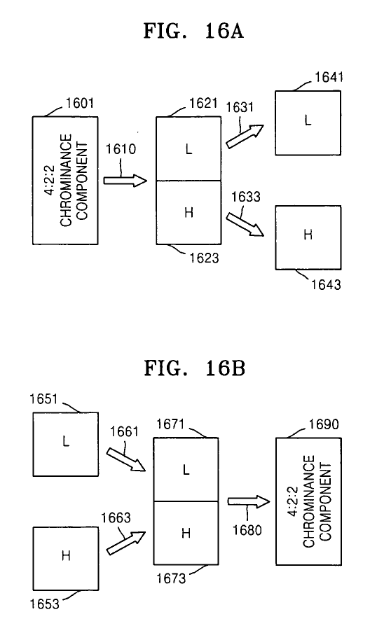

FIG. 16A is a block diagram illustrating a video encoding method of extending a 4:2:0 format to a 4:2:2 format by applying an analysis filter that has a lifting structure to a chrominance component in a vertical direction to obtain a hierarchical structure, according to an embodiment of the present invention. FIG. 16B is a block diagram illustrating a video decoding method of extending a 4:2:0 format to a 4:2:2 format by applying a synthesis filter that has a lifting structure to a chrominance component in a vertical direction to obtain a hierarchical structure, according to an embodiment of the present invention.

Referring to FIG. 16A, a vertical direction analysis filter is applied to a chrominance component 1601 included in a 4:2:2 video in order to divide the chrominance component 1601 into a chrominance component 1621 of a low-frequency band and a chrominance component 1623 of high-frequency band (1610). Next, the chrominance component 1621 of the low-frequency band is encoded, thus obtaining an encoded chrominance component 1641 of the low-frequency band (1631). The encoded chrominance component 1641 of the low-frequency band is combined with an encoded luminance component to obtain a base layer bitstream supporting a 4:2:0 format. Also, the chrominance component 1623 of the high-frequency band is encoded, thus obtaining a chrominance component 1643 of the high-frequency band (1633). An enhancement layer bitstream for making the 4:2:2 video is generated from the encoded chrominance component 1643 of the high-frequency band.

Referring to FIG. 16B, even if a video decoding apparatus compatible to the 4:2:0 format receives a scalable bitstream including a base layer bitstream and an enhancement layer bitstream, the video decoding apparatus can reproduce the 4:2:0 original video by extracting only the base layer bitstream from the scalable bitstream and decoding the base layer bitstream while disregarding the enhancement layer bitstream. Thus the existing video decoding apparatus, e.g., the VC-1 decoder, can restore a bitstream having an extended format, i.e., it can achieve forward compatibility. In detail, a chrominance component 1651 of a low-frequency band that is contained in the base layer bitstream is decoded, thus obtaining a chrominance component 1671 of the low-frequency band (1661). The chrominance component 1671 of the low-frequency band is combined with a decoded luminance component in order to obtain the 4:2:0 restored video (1680). In the case of a video decoding apparatus supporting the 4:2:2 format, first, the base layer bitstream is decoded in order to obtain the 4:2:0 restored video. Additionally, a chrominance component 1653 of a high-frequency band that is contained in the enhancement layer bitstream is decoded, thus obtaining a chrominance component 1673 of the high-frequency band (1663). The chrominance component 1673 of the high-frequency band and the chrominance component 1671 of the low-frequency band that is contained in the 4:2:0 restored video, are combined and then the combined result and a decoded luminance component form a 4:2:2 restored video.

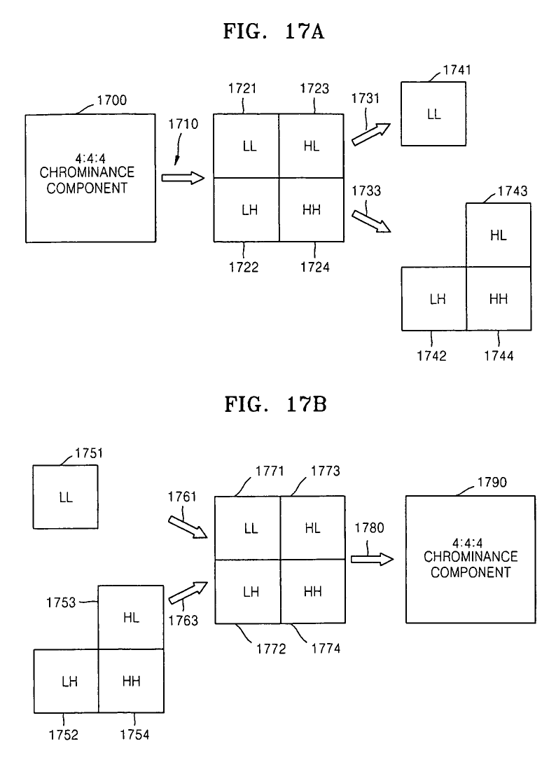

FIG. 17A is a block diagram illustrating a video encoding method of extending a 4:2:0 format to a 4:2:2 or 4:4:4 format by applying an analysis filter that has a lifting structure to a chrominance component in a horizontal/vertical direction, according to an embodiment of the present invention. FIG. 17B is a block diagram illustrating a video decoding method of extending a 4:2:0 format to a 4:2:2 or 4:4:4 format by applying a synthesis filter that has a lifting structure to a chrominance component in a horizontal/vertical direction, according to an embodiment of the present invention.

Referring to FIG. 17A, a horizontal direction analysis filter and a vertical direction analysis filter are sequentially applied to a chrominance component 1700 contained in a 4:4:4 video in order to obtain a chrominance component 1721 of an LL frequency band, a chrominance component 1722 of an LH frequency band, a chrominance component 1723 of an HL frequency band, and a chrominance component 1724 of an HH frequency band (1710). Then the chrominance component 1721 of the LL frequency band is encoded, thus obtaining a chrominance component 1741 of the LL frequency band (1731). The chrominance component 1741 of the LL frequency band and an encoded luminance component form a base layer bitstream compatible with the 4:2:0 format. The chrominance component 1722 of the LH frequency band, the chrominance component 1723 of the HL frequency band, and the chrominance component 1724 of the HH frequency band are respectively encoded, thus obtaining an encoded chrominance component 1742 of the LH frequency band, an encoded chrominance component 1743 of the HL frequency band, and an encoded chrominance component 1744 of the HH frequency band (1733). An enhancement layer bitstream for making a 4:2:2 format or 4:4:4 format is generated from the encoded chrominance component 1742 of the LH frequency band, the encoded chrominance component 1743 of the HL frequency band, and the encoded chrominance component 1744 of the HH frequency band. Here, the enhancement layer bitstream may consist of a first enhancement layer bitstream for making the 4:2:2 format and a second enhancement layer bitstream for making the 4:4:4 format.

Referring to FIG. 17B, even if a video decoding apparatus compatible with a 4:2:0 format receives a scalable bitstream containing a base layer bitstream and an enhancement layer bitstream, the video decoding apparatus extracts only the base layer bitstream from the scalable bitstream and decodes it to obtain the 4:2:0 original video while disregarding the enhancement layer bitstream. Thus, even the existing video decoding apparatus, e.g., the VC-1 decoder, can achieve forward compatibility that enables a bitstream in an extended format to be restored. Specifically speaking, a chrominance component 1751 of an LL frequency band that is contained in the base layer bitstream is decoded thus obtaining a chrominance component 1771 of the LL frequency band (1761). The chrominance component 1771 of the LL frequency band and a decoded luminance component form a 4:2:0 restored video. In the case of a video decoding apparatus supporting a 4:2:2 or 4:4:4 format, first, the base layer bitstream is decoded in order to obtain a 4:2:0 restored video. In addition, a chrominance component 1752 of an LH frequency band, a chrominance component 1753 of an HL frequency band, and a chrominance component 1754 of an HH frequency band that are contained in the enhancement layer bitstream are respectively decoded in order to obtain a chrominance component 1772 of an LH frequency band, a chrominance component 1773 of an HL frequency band, and a chrominance component 1774 of an HH frequency band (1763). The chrominance component 1772 of the LH frequency band, the chrominance component 1773 of the HL frequency band, the chrominance component 1774 of the HH frequency band, and the chrominance component 1771 of the LL frequency band that is contained in the 4:2:0 restored video are combined in order to produce a 4:4:4 restored video, together with a decoded luminance component. The chrominance component 1772 of the LH frequency band, and the chrominance component 1771 of the LL frequency band that is contained in the 4:2:0 restored video can be combined in order to obtain the 4:2:2 restored video, together with a decoded luminance component format.

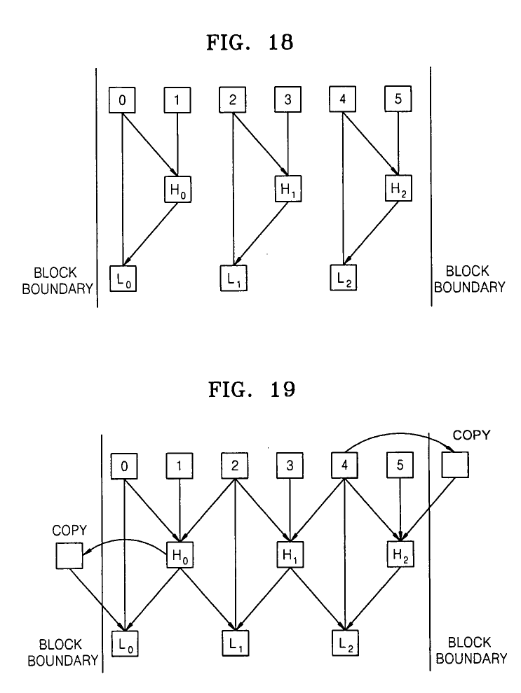

FIG. 18 is a diagram illustrating application of a Haar filter having a lifting structure to a one-dimensional (1D) pixel array by using Equations (1) through (3), according to an embodiment of the present invention.

FIG. 19 is a diagram illustrating application of a 5/3 tap wavelet filter having a lifting structure to a 1D pixel array by using Equations (1), (2), and (4), according to an embodiment of the present invention. In this case, three neighboring pixels adjacent to a target pixel are applied to a high-frequency band and five neighboring pixels are applied to a low-frequency band.

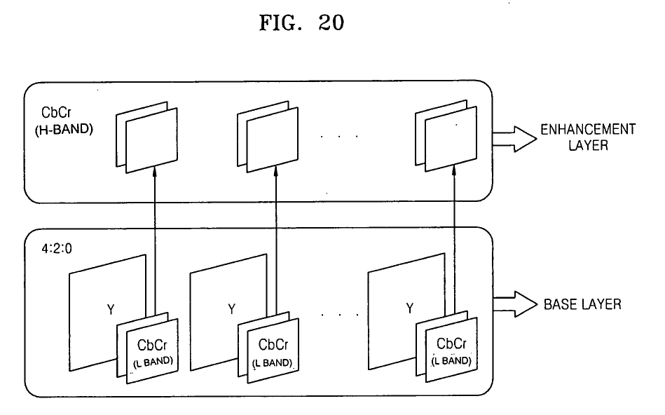

FIG. 20 is a diagram illustrating a hierarchical structure of a bitstream for extending a 4:2:0 format to a 4:2:2 format according to an embodiment of the present invention. A low-frequency band component that is contained in a chrominance component in the vertical direction, and a luminance component are encoded at a base layer in the 4:2:0 format. Then in order to extend the 4:2:0 format to the 4:2:2 format, a high-frequency band component that is contained in the chrominance component in the vertical direction is additionally encoded at an enhancement layer.

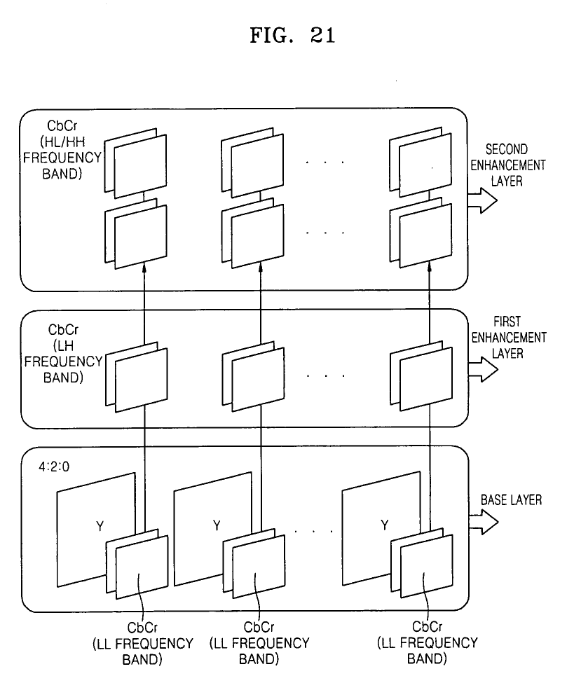

FIG. 21 is a diagram illustrating a hierarchical structure of a bitstream for extending a 4:2:0 format to a 4:2:2 format and a 4:4:4 format according to an embodiment of the present invention. An LL frequency band component contained in a chrominance component, and a luminance component are encoded at a base layer in the 4:2:0 format. Then in order to extend the 4:2:0 format to the 4:2:2 format, an LH frequency band component in the chrominance component is additionally encoded at a first enhancement layer, and in order to extend the 4:2:0 format to the 4:4:4 format, an HL frequency band component and an HH frequency band component included in the chrominance component are additionally encoded at a second enhancement layer.

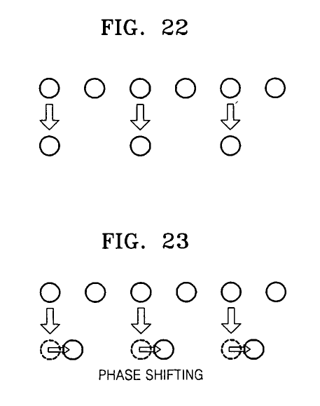

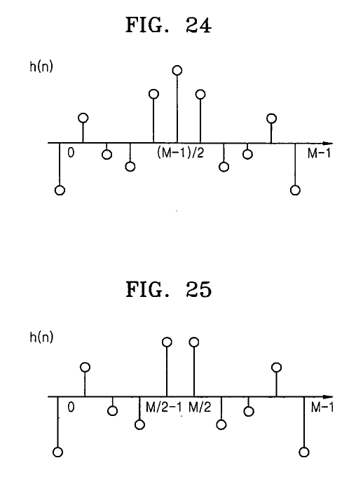

FIG. 22 is a diagram illustrating application of odd-numbered symmetrical filters for 2:1 down sampling according to an embodiment of the present invention. Since the total number of filter taps is an odd number, filter values h(n) to the left and right sides of each coefficient have the same symmetric structures. For example, in the case of odd-numbered symmetric filters, the distribution of filter values is as illustrated in FIG. 24. If odd-numbered symmetric filters are used, pixels are respectively located at the even-numbered locations of the original pixels after performing down sampling.

FIG. 23 is a diagram illustrating application of even-numbered symmetrical filters for 2:1 down sampling according to an embodiment of the present invention. Since the total number of filter taps is an even number, filter values h(n) to the right and left sides of two adjacent coefficients have the same symmetric structures. Thus phase shifting occurs by half a pixel at the even-numbered locations of the original pixels. In the case of even-numbered symmetric filters, the distribution of filter values is as illustrated in FIG. 25.

When a chrominance component is down sampled in the horizontal direction in order to transform a 4:4:4 format into a 4:2:2 format, the phase of the chrominance component needs to be adjusted to coincide with that of an even-numbered luminance component. To this end, as described above with reference to FIGS. 22 and 24, odd-numbered symmetric filters are applied in the horizontal direction. The 5/3 tap wavelet filter described above using Equations (1), (2) and (4) may be used as the odd-numbered symmetric filters. If even-numbered symmetric filters are applied to the chrominance component, the phase of the chrominance component in the horizontal direction becomes different from that of the original chrominance component in the 4:2:2 format. Thus if the chrominance component is restored in the 4:4:4 format, an error between the chrominance component in the 4:2:2 format and the chrominance component in the 4:4:4 format is large.

When a chrominance component is down sampled in the vertical direction in order to transform the 4:2:2 format into the 4:2:0 format, the phase of the chrominance component needs to be shifted by a half pixel relative to the phase of an even-numbered luminance component. To this end, as described above with reference to FIGS. 23 and 25, even-numbered symmetric filters are applied in the vertical direction. The Haar filter as described above using Equations (1) through (3) may be used as the even-numbered symmetric filters. If odd-numbered symmetric filters are applied to the chrominance component, the phase of the chrominance component in the vertical direction becomes equal to that of the original chrominance component in the 4:2:2 format. Thus if the chrominance component is restored in the 4:2:2 format, an error between the chrominance component in the 4:2:2 format and the chrominance component in the 4:4:4 format is large.

In addition, in the embodiments described above, the supporting of two codecs in which two video formats are different respectively is explained based on the example of the scalable bitstream formed by one base layer bitstream and one enhancement layer bitstream. However, the present invention can also support two or more codes by using a plurality of enhancement layer bitstreams.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, in order to provide a new video codec guaranteeing forward compatibility, a video encoder generates a scalable bitstream formed with a base layer bitstream and an enhancement layer bitstream. Then, a conventional base decoder which receives the scalable bitstream decodes the scalable bitstream, by using the base layer bitstream obtained from the scalable bitstream, and an improved decoder decodes the scalable bitstream, by using both the base layer bitstream and the enhancement layer bitstream. In this way, both the improved video codec and the conventional video code share the scalable bitstream in a harmonized way. More specifically, according to the present invention, a conventional Windows Media Video (WMV) codec or VC-1 codec can be used together with a new video codec supporting a new video format.

Thus, since the video codec according to the present invention provides the forward compatibility, the present invention can be applied to a variety of video codecs regardless of a supported video format, for example, to the conventional basic video codecs as well as improved video codecs mounted on a wired or wireless electronic device, such as a mobile phone, a DVD player, a portable music player, or a car stereo unit.

While aspects of the present invention has been particularly shown and described with reference to differing embodiments thereof, it should be understood that these exemplary embodiments should be considered in a descriptive sense only and not for purposes of limitation. Any narrowing or broadening of functionality or capability of an aspect in one embodiment should not considered as a respective broadening or narrowing of similar features in a different embodiment, i.e., descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. A video encoding method of generating a scalable bitstream compatible with at least two video formats comprising:
generating an enhancement layer identifier;
generating a base layer bitstream by encoding a chrominance component of a low-frequency band and a luminance component that are included in video data; and
generating an enhancement layer bitstream by encoding a chrominance component of the remaining frequency band other than the low-frequency band that is included in the video data.

2. The method of claim 1, wherein the enhancement layer identifier is comprised in at least one of a sequence level, a GOP (group of pictures) level, a picture level, a macro block level, and a block level of the scalable bitstream.

3. The method of claim 1, wherein the enhancement layer identifier is contained in a reserved area of the scalable bitstream.

4. The method of claim 1, wherein if the video has a 4:2:2 format, the base layer bitstream comprises a chrominance component compatible with a 4:2:0 format, and the chrominance component of the low-frequency band is obtained by analysis filtering a chrominance component of the video having the 4:2:2 format in a vertical direction.

5. The method of claim 4, wherein if the video has a 4:2:2 format, the enhancement layer bitstream comprises an additional chrominance component for making the 4:2:2 format, and a chrominance component of the other frequency band comprises a chrominance component of a high-frequency band being obtained by analysis filtering the chrominance component of the video data having the 4:2:2 format in the vertical direction.

6. The method of claim 1, wherein if the video has a 4:4:4 format, the base layer bitstream comprises a chrominance component compatible with a 4:2:0 format, and the chrominance component of the low-frequency band comprises a chrominance component of a low-low frequency band obtained by analysis filtering the chrominance component of the video having the 4:4:4 format in horizontal and vertical directions.

7. The method of claim 6, wherein if the video has the 4:4:4 format, the enhancement layer bitstream comprises an additional chrominance component for making a 4:2:2 or 4:4:4 format, and chrominance components of other frequency bands comprise chrominance components of a low-high frequency band, a high-low frequency band and a high-high frequency band that are obtained by analysis filtering the chrominance component of the video having the 4:4:4 format in horizontal and vertical directions.

8. A video encoding apparatus for generating a scalable bitstream supporting at least two video formats with forward compatibility, the apparatus comprising:
an analysis filtering unit to filter a chrominance component of the video to obtain a chrominance component of a low-frequency band and a chrominance component of another frequency band;
a first encoding unit to generate a base layer bitstream by encoding a luminance component and the chrominance component of the low-frequency band of the video;
a second encoding unit to generate an enhancement layer bitstream by encoding the chrominance component of the remaining frequency band other than the low-frequency band; and
a bitstream combining unit to generate the scalable bitstream by combining the base layer bitstream and the enhancement layer bitstream and to insert an enhancement layer identifier into the combined result.

9. The apparatus of claim 8, wherein the enhancement layer identifier is comprised in at least one of a sequence level, a GOP (group of pictures) level, a picture level, a macro block level, and a block level of the scalable bitstream.

10. The apparatus of claim 8, wherein the enhancement layer identifier is comprised in a reserved area of the scalable bitstream.

11. The apparatus of claim 8, wherein if the video has a 4:2:2 format, the base layer bitstream comprises a chrominance component compatible with a 4:2:0 format, and the chrominance component of the low-frequency band is obtained by analysis filtering a chrominance component of the video having the 4:2:2 format in a vertical direction.

12. The apparatus of claim 11, wherein if the video has a 4:2:2 format, the enhancement layer bitstream comprises an additional chrominance component for making the 4:2:2 format, and a chrominance component of the other frequency band comprises a chrominance component of a high-frequency band being obtained by analysis filtering the chrominance component of the video having the 4:2:2 format in the vertical direction.

13. The apparatus of claim 8, wherein if the video has a 4:4:4 format, the base layer bitstream comprises a chrominance component compatible with a 4:2:0 format, and the chrominance component of the low-frequency band comprises a chrominance component of a low-low frequency band obtained by analysis filtering the chrominance component of the video having the 4:4:4 format in horizontal and vertical directions.

14. The apparatus of claim 13, wherein if the video has the 4:4:4 format, the enhancement layer bitstream contains an additional chrominance component for making a 4:2:2 or 4:4:4 format, and chrominance components of the other frequency bands comprise chrominance components of a low-high frequency band, a high-low frequency band and a high-high frequency band that are obtained by analysis filtering the chrominance component of the video having the 4:4:4 format in horizontal and vertical directions.

15. The apparatus of claim 13, wherein odd-numbered symmetric filters are applied to the chrominance component of the video in the horizontal direction, and even-numbered symmetric filters are applied to the filtered result in the vertical direction.

16. A video decoding apparatus comprising:
an enhancement layer identifier checking unit to check if a bitstream comprises an enhancement layer identifier;
a first decoding unit to generate a restored video in a first video format by decoding a base layer bitstream included in the bitstream, which does not comprise the enhancement layer identifier;
a second decoding unit to generate a chrominance component of the remaining frequency band other than a low-frequency band by decoding an enhancement layer bitstream included in the bitstream, which comprises the enhancement layer identifier; and
a synthesis filtering unit to generate a restored video in a second video format by combining a chrominance component of the low-frequency band that is contained in the restored video in the first video format generated by the first decoding unit and the chrominance component of the remaining frequency band generated by the second decoding unit, and to combine the combined result and a luminance component comprised in the restored video in the first video format.

17. The apparatus of claim 16, wherein if the first video format is 4:2:0 and the second video format is 4:2:2 or 4:4:4, the base layer bitstream comprises a chrominance component supporting the 4:2:0 format, and the enhancement layer bitstream contains additional chrominance components for making the 4:2:2 or 4:4:4 format.

18. The apparatus of claim 17, wherein the chrominance component supporting the 4:2:0 format comprises a chrominance component of a low-frequency band, the additional chrominance components for making the 4:2:2 format comprise a chrominance component of a high-frequency band, and a chrominance component compatible with the 4:2:2 format is generated by synthesis filtering the chrominance component of the low-frequency band and the chrominance component of the remaining frequency band.

19. The apparatus of claim 17, wherein the chrominance component compatible with the 4:2:0 format comprises a chrominance component of a low-low frequency band, the additional chrominance components for making the 4:4:4 format comprise a chrominance component of a low-high frequency band, a chrominance component of a high-low frequency band, and a chrominance component of a high-high frequency band, and a chrominance component compatible with the 4:4:4 format is obtained by synthesis filtering the chrominance component of the low-low frequency band, the chrominance component of the low-high frequency band, the chrominance component of the high-low frequency band, and the chrominance component of the high-high frequency band in a vertical or horizontal direction.

20. A video decoding method comprising:
checking whether a bitstream comprises an enhancement layer identifier;
decoding video data in a first video format by decoding a base layer bitstream included in a bitstream which does not comprise the enhancement layer identifier;
decoding a chrominance component of another frequency band by decoding an enhancement layer bitstream included in the bitstream which comprises the enhancement layer identifier; and
decoding video data in a second video format by combining a chrominance component of a low-frequency band that is included in decoded video in the first video format and a chrominance component of a high-frequency band that is included in the chrominance component in the remaining frequency band other than the low-frequency band and then using a luminance component in the decoded video in the first video format.

21. The method of claim 20, wherein if the first video format is 4:2:0 and the second video format is 4:2:2 or 4:4:4, the base layer bitstream comprises a chrominance component compatible with the 4:2:0 format, and the enhancement layer bitstream contains additional chrominance components for making the 4:2:2 or 4:4:4 format.

22. The method of claim 21, wherein the chrominance component compatible with the 4:2:0 format comprises a chrominance component of a low-frequency band, the additional chrominance components for making the 4:2:2 format comprise a chrominance component of a high-frequency band, and a chrominance component compatible with the 4:2:2 format is generated by synthesis filtering the chrominance component of the low-frequency band and the chrominance component of the remaining frequency band.

23. The method of claim 21, wherein the chrominance component compatible with the 4:2:0 format comprises a chrominance component of a low-low frequency band, the additional chrominance components for making the 4:4:4 format comprise a chrominance component of a low-high frequency band, a chrominance component of a high-low frequency band, and a chrominance component of a high-high frequency band, and a chrominance component compatible with the 4:4:4 format is obtained by synthesis filtering the chrominance component of the low-low frequency band, the chrominance component of the low-high frequency band, the chrominance component of the high-low frequency band, and the chrominance component of the high-high frequency band in a vertical or horizontal direction.

24. A computer readable medium having computer readable code to implement a method of decoding a scalable bitstream supporting at least two video formats with forward compatibility, wherein the scalable bitstream comprises:
an enhancement layer identifier;
a base layer bitstream being obtained by encoding a chrominance component of a low-frequency band and a luminance component that are comprised in video data; and
an enhancement layer bitstream being obtained by encoding a chrominance component of the remaining frequency band other than the low-frequency band that is comprised in the video data.

25. A video data decoding method comprising:
receiving an enhancement layer identifier;
decoding video data in a first video format which is different from a second video format based on the enhancement layer identifier.
